(19) United States
(12) Patent Application Publication
(10) Pub. No.: US 2011/0173063 A1
(43) Pub. Date: Jul. 14, 2011

(54) ADVERTISER VALUE-BASED BID MANAGEMENT IN ONLINE ADVERTISING

(75) Inventors: Tarun Bhatia, Burbank, CA (US); Darshan V. Kantak, Pasadena, CA (US); Eric Theodore Bax, Pasadena, CA (US); Chris Jaffe, Burlingame, CA (US)

(73) Assignee: Yahoo! Inc., Sunnyvale, CA (US)

(21) Appl. No.: 12/685,329

(22) Filed: Jan. 11, 2010

(51) Int. Cl. G06Q 30/00; G06Q 10/00

(52) U.S. Cl. 705/14.45; 705/14.46; 705/14.71

(57) ABSTRACT

The present invention provides methods and systems for use in online advertising campaign management, including bid management in an online advertising auction. Techniques are provided in which a benchmark set of previously served advertisements is identified, and associated performance information is obtained. During an online auction, when an advertisement impression opportunity becomes available, information obtained using a machine learning technique may be utilized in forecasting an advertiser value-based metric associated with the opportunity, using the benchmark set of advertisements and the associated performance. The forecasted advertiser value-based metric can be used in determining bidding and pricing associated with the opportunity.

### BACKGROUND

Online advertising continues to grow in scale and importance. As advertisers' campaigns grow, so does the scale and difficulty of managing them, including managing online advertising auction bidding and purchasing. Networks and advertising exchanges have developed and help to some extent centralize campaign management. However, campaign management, including bid determination, continues to present difficulties and to strain resources that might more optimally be used directly for advertising. This strain in turn leads to a suboptimal marketplace as a whole. Yet, advertisers must be able to optimize return on investment for advertising spend by optimizing purchasing and bidding.

In additional to problems of scale, campaign and bid optimization is made even more difficult by the fact that pricing or pay-by metrics often do not correspond or exactly correspond to metrics that the advertiser values or most values. Furthermore, impressions typically become available in online advertising exchange auctions in near real-time and often do not correspond exactly to anticipated characteristics or categories, further complicating bidding.

There is a need for techniques for use in online advertising campaign management, including bid management and optimization in an online advertising auction.

### SUMMARY

Some embodiments of the invention provide methods and systems for use in online advertising campaign management, including bid management in an online advertising auction. Methods and systems are provided in which a benchmark set of previously served advertisements is identified, and associated performance information is obtained. During an online auction, when an advertisement impression opportunity becomes available, a machine learning technique may be employed in forecasting an advertiser value-based metric associated with the opportunity, using the benchmark set of advertisements and the associated performance. The forecasted value-based metric can be used in determining, in real-time or near real-time, bidding and pricing associated with the opportunity.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention; and

FIG. 4 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

Some embodiments of the present invention provide methods and systems for use in online advertising campaign management, including bid management in an online advertising auction. Methods and systems are provided in which a benchmark set of previously served advertisements is identified, and associated performance information is obtained. During an online auction, when an advertisement impression serving opportunity becomes available, a machine learning technique may be employed, whether online or with reference to offline information, tables or indices, using the benchmark set of advertisements and the associated performance, in forecasting an advertiser value-based metric associated with the opportunity. The forecasted value-based metric can be used in determining real-time or near real-time bidding associated with the opportunity. The forecasted value-based metric can further be used in determining pricing associated with the opportunity.

In some embodiments, pricing of the advertisement impression corresponding to the opportunity is determined in accordance with an agreement with an advertiser or a proxy of the advertiser. The pricing may be adjusted to reflect a relationship or ratio between a performance with respect the value-based metric indicated in the agreement and the forecasted performance of the advertisement impression with regard to the value-based metric.

Some embodiments of the invention provide partially or fully automated, standardized, or normalized ways for advertisers to bid on and purchase advertising impressions, maintaining quality and desired performance while minimizing advertiser management effort and time.

Some embodiments of the invention provide advertisers with tools for managing advertising campaigns, including bidding on and purchasing advertising, such as advertising impressions. Some embodiments of the invention provide an advertiser with tools, such as automated or partially automated tools, that facilitate or implement bidding determinations and bidding on behalf of the advertiser, in a way that is optimized from the perspective of value to the advertiser relative to cost. Some embodiments of the invention can also be utilized by an auction facilitator, or operator, for example, in determining pricing associated with impressions.

Advertising impressions may be priced based on a metric, often a front-end metric, such as an impression-based metric (as in CPM, or cost per million impressions arrangements), or a click-based metric (as in a CPC, or cost per click, arrangement), or some other parameter or a combination of parameters. However, value to the advertiser from the impressions may be measured or better measured by a different, often more down-stream, or back-end, metric, which may be based on one or more parameters such as brand awareness achieved, conversions, some measurable proxy for conversions, etc., or some combination of parameters. The relationship or ratio of the pricing metric to the value-based metric may be critical to an advertiser. However, it may be challenging to determine or predict this for a particular impression serving opportunity, much less for a large quantity of different opportunities coming available in an online advertising network or exchange auction in real time or near real-time (such as with sometimes only a fraction of a second between availability and bidding).

Some embodiments of the invention include identification, such as automatic or partially automatic identification, of a set of previously served advertisement impressions, or a benchmark net of previously served advertisement impressions. The benchmark set can be used in forecasting performance of an impression serving opportunity that becomes available, such as in real-time or near real-time in an online auction.

In some embodiments, statistical or machine learning techniques may be used in identifying an optimal benchmark set. For example, suppose that a particular advertiser supplies requirements or criteria such as targeting criteria for anticipated impressions. A benchmark set may be determined that is predicted to perform similarity to anticipated impressions subject to such criteria, with regard to correlation or scaling of the pricing metric to the value-based metric. Of course, many other criteria or features can apply or be utilized in selection of the benchmark set, including, for example, other characteristics or categories associated with anticipated impressions, characteristics or categories associated with the advertiser, the advertising campaign, or the particular aspect or portion of the campaign that is involved. Still further, any other characteristics, categories or features associated with any element of serving of anticipated impressions may be considered, including, for example, anticipated serving context, including predicted publishers or publisher sites. Some such criteria may depend, or depend in part, on context issues not directly related to the advertiser, such as, for example, predicted or forecasted pertinent impression opportunity inventory over a certain period of time, etc.

In some embodiments, the benchmark set may be presented to the advertiser before use. Additionally, in some embodiments, the advertiser may participate in some way in selection, modification, or refinement of the benchmark set. For example, a benchmark set may be presented for approval to the advertiser prior to use. Furthermore, in some embodiments, input may be obtained from the advertiser specifically with regard to selection of the benchmark set. Still further, in some embodiments, the advertiser has options including full approval, partial approval, or modification. In some embodiments, the advertiser may provide feedback regarding modification, may participate in an interactive process for benchmark set selection, etc.

In various embodiments of the invention, various aspects or elements may be performed offline, online, or a combination thereof. In some embodiments, offline determinations are made, which may be used to speed, or partially or fully replace, online determination, since online determinations may need to be made in, for example, a small fraction of a second. For example, in some embodiments, machine learning techniques or models may be used to generate tables or indices. The tables or indices can used for online look-up, for instance. For example, tables can be generated that apply to categories or ranges of anticipated impressions, allowing or partially allowing look-up of an applicable predicted value-based metric.

In some embodiments, a machine learning model may be generated using the benchmark set, as well as feature and performance information associated with the set. The machine learning model may be used online, or may be used to forecast performance of an impression opportunity that becomes available online during an auction, or may be used to generate tables and indices from which such a determination may be made. The model may utilize diverse feature information relating to the benchmark set. The feature information can include context and purchasing information (such as serving context information, etc.), user usage information (such as time spent viewing advertisement, etc.), or features of the advertisement itself (such as size, textual or graphical characteristics, etc.). The feature information can of course also include performance information of various types and relating to various stages or times, including value-based metric information.

In some embodiments, if information exactly relating to value-based metric performance cannot be obtained, other related performance information may be used to approximate or estimate an actual or derived value-based metric performance. Furthermore, in some embodiments, various techniques can be used to obtain or supplement available value-based metric information, including online or offline techniques. For example, for brand awareness, surveys may be used.

Some embodiments of the invention include aspects pertaining to advertiser agreements. For example, an advertiser agreement may specify a particular metric, such as a value-based metric, or forecasted metric, such as in association with a certain price for impressions. During an online auction, if an impression opportunity becomes available that may be forecasted to offer, for example, one half or twice as much value-based performance as anticipated in the agreement, pricing may be adjusted to account for this (such as charging half the cost or twice the cost, respectively). In some embodiments, such flexibility can be included or written into advertiser agreements or contracts. This may allow advertisers the advantage and comfort of specifying a suitable value-based performance level and associated return on investment, while yet allowing flexibility with regard to satisfying the agreement. This flexibility may in turn lead to better or faster satisfaction of the agreement, as well as better and more optimized usage of impression inventory, across multiple advertisers and campaigns. In some embodiments, pricing may be determined dynamically during the auction, in real-time or near real-time. This can allow great granularity and specificity in bidding and pricing in connection with opportunities, while still satisfying agreements with, and expectations of, advertisers.

In some embodiments, during an auction, when an impression opportunity becomes available, a machine learning model, or tables generated therefrom, may be utilized to determine a forecasted value-based performance of an available impression opportunity. This forecasted value can then be used in determining or facilitating bidding, as well as potentially for determining or facilitating determination of pricing.

In some embodiments, performance of advertisement impressions, for which bidding is facilitated, for example, is tracked. For example, downstream information on advertisement impression performance can be obtained and stored, such as in a database, and used for various purposes. For example, such information can be used in various feedback loops. In some embodiments, the tracking and feedback loops may be partially or fully automated. In some embodiments, the tracked information can be used to refine advertisement inventory management. As another example, such information can be fed back into a machine learning model, such as a model based on the benchmark set, and used to refine the model, which can lead to refined bidding and pricing determinations, better benchmark set selection, etc. Furthermore, tracked information can be shared with or reported to advertisers, for instance, for their information and refinement of their advertising campaigns. The information can also be used to give advertisers greater confidence in upcoming campaign performance, or even to suggest inventory or agreements or specific pricing. Still further, in some embodiments, subject to any privacy considerations, the tracked information (as well as earlier information such as benchmark set information, bidding and pricing determination information, etc.), can be collected, organized and marketed or sold to various entities for purposes such as market research and analysis.

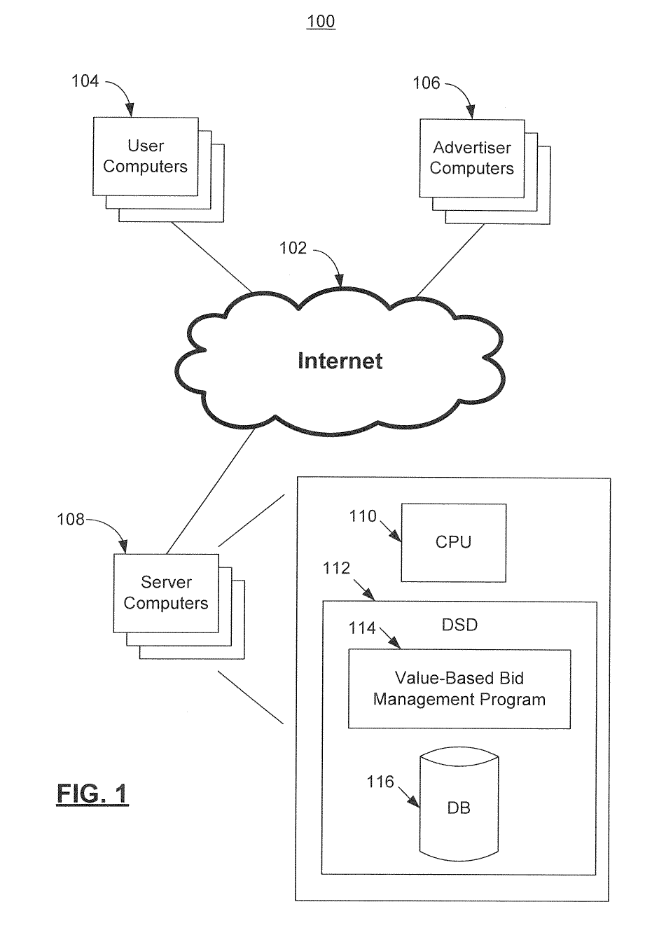

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Value-Based Bid Management Program 114.

The Program 114 is intended to broadly include all programming, applications, algorithms, software and other tools necessary to implement or facilitate methods and systems according to embodiments of the invention. The elements of the Program 114 may exist on a single server computer or be distributed among multiple computers or devices.

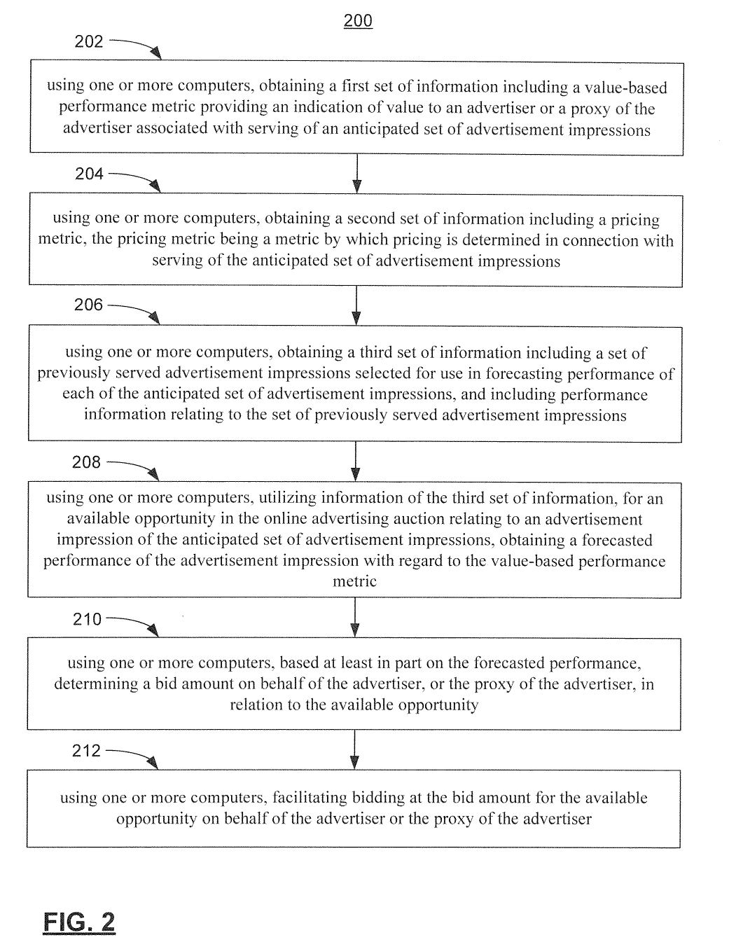

FIG. 2 is a flow diagram of a method 200 according to one embodiment of the invention. At step 202, using one or more computers, a first set of information is obtained, including a value-based performance metric providing an indication of value to an advertiser, or a proxy of the advertiser, associated with anticipated serving of a set of advertisement impressions.

At step 204, using one or more computers, a second set of information is obtained, including a pricing metric, the pricing metric being a metric by which pricing is determined in connection with serving of the anticipated set of advertisement impressions.

At step 206, using one or more computers, a third set of information is obtained, including a set of previously served advertisement impressions selected for use in forecasting performance of each of the anticipated set of advertisement impressions, and including obtaining performance information relating to the set of previously served advertisement impressions.

At step 208, using one or more computers, utilizing information of the third set of information, for an available opportunity in the online advertising auction relating to an advertisement impression of the set of advertisement impressions, a forecasted performance is obtained of the advertisement impression with regard to the value-based metric.

At step 210, using one or more computers, based at least in part on the forecasted performance, a bid amount is determined on behalf of the advertiser, or the proxy of the advertiser, in relation to the available opportunity.

At step 212, using one or more computers, bidding is facilitated at the bid amount for the available opportunity on behalf of the advertiser or the proxy of the advertiser.

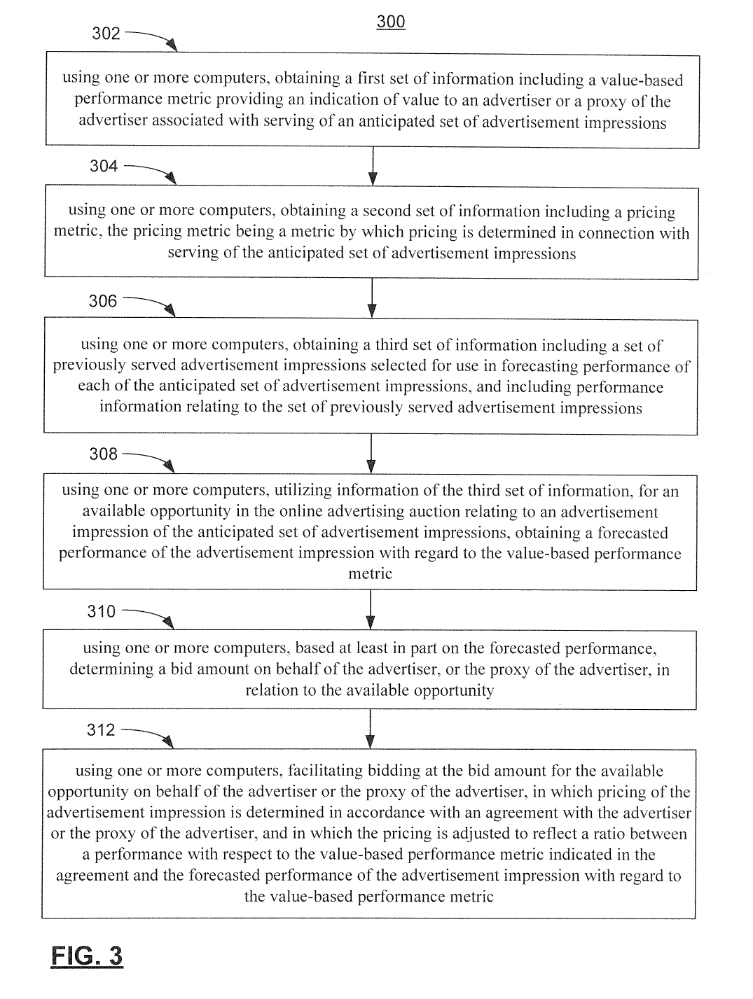

FIG. 3 is a flow diagram illustrating a method 300 according to one embodiment of the invention. Steps 302 to 310 are similar to steps 202 to 210 as depicted in FIG. 2.

At step 312, using one or more computers, bidding is facilitated at the bid amount for the available opportunity on behalf of the advertiser or the proxy of the advertiser. Pricing of the advertisement impression is determined in accordance with an agreement with the advertiser or the proxy of the advertiser. The pricing is adjusted to reflect a ratio between a performance with respect the value-based metric indicated in the agreement and the forecasted performance of the advertisement impression with regard to the value-based metric.

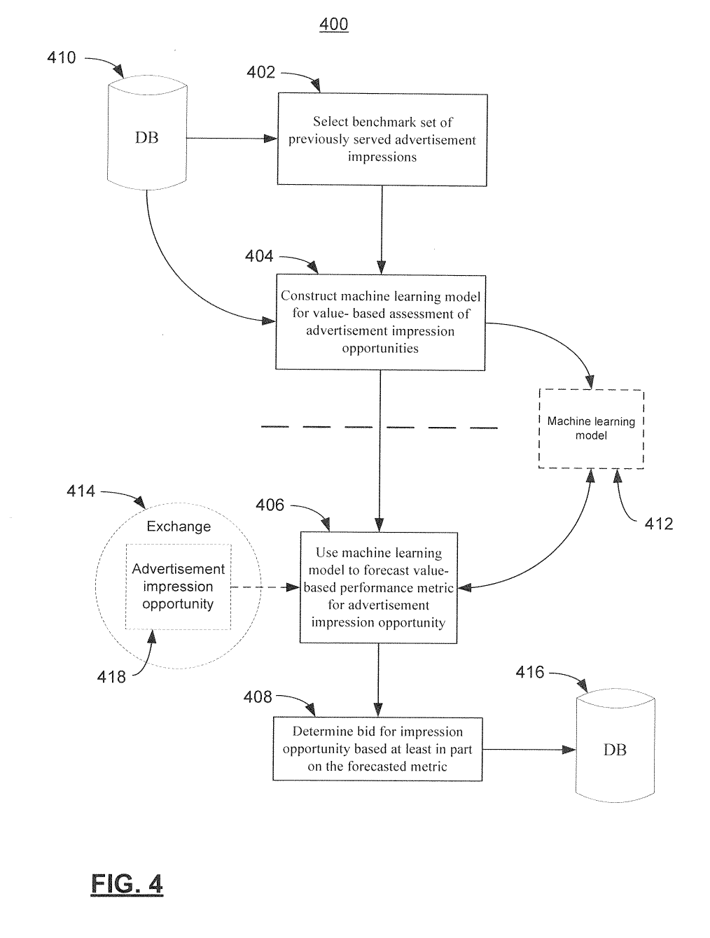

FIG. 4 is a flow diagram of a method 400 according to one embodiment of the invention. At step 402, a benchmark set of previously served advertisement impressions is selected, using information obtained from a database 410.

At step 404, a machine learning model 412 is constructed, using information from the database 410, for value-based assessment of advertisement impression opportunities, and using feature and performance information associated with the benchmark set of previously served advertisement impressions.

At step 406, during a real-time or near real-time advertising auction, the machine learning model 412 is used to forecast a value-based performance metric for an available advertisement impression opportunity 418, available from an online advertising exchange 414.

At step 408, based at least in part on the forecasted value-based performance metric, a bid is determined for the advertisement impression opportunity 418. The bid is stored in a database 416. In some embodiments, pricing may also be determined, and purchase may be facilitated or implemented.

The foregoing description is intended merely to be illustrative, and other embodiments are contemplated within the spirit of the invention.

1. A method for use in association with an online advertising auction, comprising:
using one or more computers, obtaining a first set of information comprising a value-based performance metric providing an indication of value to an advertiser or a proxy of the advertiser associated with serving of an anticipated set of advertisement impressions;
using one or more computers, obtaining a second set of information comprising a pricing metric, the pricing metric being a metric by which pricing is determined in connection with serving of the anticipated set of advertisement impressions;
using one or more computers, obtaining a third set of information comprising a set of previously served advertisement impressions selected for use in forecasting performance of each of the anticipated set of advertisement impressions, and comprising performance information relating to the set of previously served advertisement impressions;
using one or more computers, utilizing information of the third set of information, for an available opportunity in the online advertising auction relating to an advertisement impression of the anticipated set of advertisement impressions, obtaining a forecasted performance of the advertisement impression with regard to the value-based performance metric;
using one or more computers, based at least in part on the forecasted performance, determining a bid amount on behalf of the advertiser, or the proxy of the advertiser, in relation to the available opportunity; and
using one or more computers, facilitating bidding at the bid amount for the available opportunity on behalf of the advertiser or the proxy of the advertiser.

2. The method of claim 1, wherein pricing of the advertisement impression is determined in accordance with an agreement with the advertiser or the proxy of the advertiser, and wherein the pricing is adjusted depending on the forecasted performance of the available opportunity with regard to the value-based performance metric.

3. The method of claim 1, wherein pricing of the advertisement impression is determined in accordance with an agreement with the advertiser or the proxy of the advertiser, and wherein the pricing is adjusted to reflect a ratio between a performance with respect the value-based performance metric indicated in the agreement and the forecasted performance of the advertisement impression with regard to the value-based performance metric.

4. The method of claim 1, wherein obtaining the value-based performance metric comprises obtaining information relating to a single performance parameter.

5. The method of claim 1, wherein obtaining the value-based performance metric comprises obtaining information relating to more than one performance parameter.

6. The method of claim 1, wherein obtaining the value-based performance metric comprises obtaining information relating to at least one of a number of impressions, a number of clicks, a number of conversions, and a degree of achieved brand awareness.

7. The method of claim 1, comprising obtaining the pricing metric, wherein the pricing metric comprises at least one of a number of impressions and a number of clicks.

8. The method of claim 1, comprising selecting the set of previously served advertisement impressions, and wherein selecting the set of previously served advertisement impressions comprises selecting impressions for which a ratio of the value-based performance metric to the pricing metric is anticipated to be similar to that of the available opportunity.

9. The method of claim 1, comprising selecting the set of previously served advertisement impressions, and wherein selecting previously served advertisement impressions comprises selecting an optimized set of impressions for which the ratio of the value-based performance metric to the pricing metric is anticipated to be similar to that of the available opportunity.

10. The method of claim 1, comprising using a machine learning technique in selecting the set of previously served advertisement impressions.

11. The method of claim 1, comprising obtaining approval from the advertiser or the proxy of the advertiser in selection of the set of previously served advertisement impressions.

12. The method of claim 1, wherein obtaining a forecasted performance of the advertisement impression with regard to the value-based performance metric comprises using a machine learning model, and wherein the machine learning model utilizes feature and performance information relating to the set of previously served advertisement impressions.

13. The method of claim 1, comprising determining the bid amount during the online advertising auction and after the available opportunity becomes available.

14. The method of claim 1, comprising determining the bid amount during the online advertising auction and in real-time or near real-time.

15. The method of claim 1, comprising implementing a bid at the bid amount on behalf of the advertiser or the proxy of the advertiser.

16. A system comprising:
one or more server computers connected to a network; and
one or more databases connected to the one or more servers;
wherein the one or more server computers are for:
obtaining a first set of information comprising a value-based performance metric providing an indication of value to an advertiser or a proxy of the advertiser associated with serving of an anticipated set of advertisement impressions;
obtaining a second set of information comprising a pricing metric, the pricing metric being a metric by which pricing is determined in connection with serving of the anticipated set of advertisement impressions;
obtaining a third set of information comprising a set of previously served advertisement impressions selected for use in forecasting performance of each of the anticipated set of advertisement impressions, and comprising performance information relating to the set of previously served advertisement impressions;
utilizing information of the third set of information, for an available opportunity in an online advertising auction relating to an advertisement impression of the anticipated set of advertisement impressions, obtaining a forecasted performance of the advertisement impression with regard to the value-based performance metric;
based at least in part on the forecasted performance, determining a bid amount on behalf of the advertiser, or the proxy of the advertiser, in relation to the available opportunity; and
facilitating bidding at the bid amount for the available opportunity on behalf of the advertiser or the proxy of the advertiser.

17. The system of claim 16, wherein the one or more server computers are connected to the Internet.

18. The system of claim 16, wherein pricing of the advertisement impression is determined in accordance with an agreement with the advertiser or the proxy of the advertiser, and wherein the pricing is adjusted depending on the forecasted performance of the available opportunity with regard to the value-based performance metric.

19. The system of claim 16, wherein pricing of the advertisement impression is determined in accordance with an agreement with the advertiser or the proxy of the advertiser, and wherein the pricing is adjusted to reflect a ratio between a performance with respect to the value-based performance metric indicated in the agreement and the forecasted performance of the advertisement impression with regard to the value-based performance metric.

20. A computer readable medium or media containing instructions for executing a method for use in association with an online advertising auction, the method comprising:
using one or more computers, obtaining a first set of information comprising a value-based performance metric providing an indication of value to an advertiser or a proxy of the advertiser associated with serving of an anticipated set of advertisement impressions;
using one or more computers, obtaining a second set of information comprising a pricing metric, the pricing metric being a metric by which pricing is determined in connection with serving of the anticipated set of advertisement impressions;
using one or more computers, obtaining a third set of information comprising a set of previously served advertisement impressions selected for use in forecasting performance of each of the anticipated set of advertisement impressions, and comprising performance information relating to the set of previously served advertisement impressions;
using one or more computers, utilizing information of the third set of information, for an available opportunity in the online advertising auction relating to an advertisement impression of the anticipated set of advertisement impressions, obtaining a forecasted performance of the advertisement impression with regard to the value-based performance metric;
using one or more computers, based at least in part on the forecasted performance, determining a bid amount on behalf of the advertiser, or the proxy of the advertiser, in relation to the available opportunity; and
using one or more computers, facilitating bidding at the bid amount for the available opportunity on behalf of the advertiser or the proxy of the advertiser;
wherein pricing of the advertisement impression is determined in accordance with an agreement with the advertiser or the proxy of the advertiser, and wherein the pricing is adjusted to reflect a ratio between a performance with respect the value-based performance metric indicated in the agreement and the forecasted performance of the advertisement impression with regard to the value-based metric.
